(19) United States
(12) Patent Application Publication
(10) Pub. No.: US 2007/0053769 A1
(43) Pub. Date: Mar. 8, 2007

(54) System for powering a vehicle air temperature control system air mover, and related method

(76) Inventors: Steven E. Schlanger, Flagstaff, AZ (US); W. Frank Ableson, Stanhope, NJ (US)

Correspondence Address: Stephen T. Sullivan, 7001 E. Paradise Drive, Scottsdale, AZ, 85254, US

(21) Appl. No.: 11/221,419

(22) Filed: Sep. 6, 2005

(51) Int. Cl. F03B 15/00; F25D 17/04; F01B 25/00

(52) U.S. Cl. 415/13; 62/186

(57) ABSTRACT

A system for powering an air mover of a vehicle air temperature control system. The air mover powering system includes first and second power sources, and a primary path positioned between the first power source and the air mover. The primary path has a first state in which the primary path electrically couples the first power source to the air mover to apply electrical power to the air mover, and a second state in which the primary path has a lower conductivity than in the first state. The system also includes a secondary path coupled between the second power source and the air mover and in parallel with the primary path. The secondary path comprises a first state in which the secondary path applies supplemental electrical power from the second power source to the air mover, and a second state that has a lower conductivity than the first state of the secondary path. A secondary path switch is operatively coupled to the secondary path and responsive to at least one of the first and second states of the primary path, wherein the secondary path switch causes the secondary path to assume the first conduction path when the primary path is in the first state, and it causes the secondary path to assume the second state when the primary path is in the second state. One or more primary path state sensors may be provided to set the state of the second path in response to the sensed state of the primary path. A controller such as a microcontroller may be used to control the second path state setting. Related methods also are disclosed.

### BACKGROUND OF THE INVENTION

1. Field of the Invention

The present invention relates to vehicle air temperature control systems, for example, such as passenger compartment heating and air conditioning systems and the like. More specifically, it relates to apparatus, systems and methods for powering and/or controlling the air mover or movers, for example, a fan, blower, and the like, for such systems.

2. Description of the Related Art

Vehicles such as automobiles, trucks, tractors, aircraft, water craft and the like routinely include air temperature control systems for controlling the air temperature of a defined space within the vehicle, such as the main passenger compartment. Such air temperature control systems routinely include one or more air movers for moving the temperature-adjusted air into, out of, and/or within the temperature-controlled compartment. Examples of air movers would include air fan assemblies and/or blowers. These air movers typically comprise a fan or blower motor for imparting the necessary mechanical force to move a fan or blower, which in turn moves the temperature-adjusted or controlled air. These air movers often have multiple speeds or air flow levels. Low speeds or levels generally are used when only minor temperature adjustments are required, while high speeds or flow rates are used when relatively large temperature adjustments or thermal loads are involved.

The air movers typically operate by inputting electrical energy into the motive force transducer, e.g., the fan or blower motor, to cause the motor to actuate and set the speed or level of operation. This typically is accomplished by providing an electrical conduit from the battery, alternator, generator or similar electrical power source to the fan or blower motor. A speed or flow rate selector, which may be a manual selector, a sensor-based processing device or the like, is used to select a desired level of operation, e.g., fan speed. That selector causes a switch or other electrical device to regulate the electrical power level provided to the fan or blower motor.

A problem that has persisted with air movers in the past is that they have not operated at maximum or optimum output, particularly as they age and wear. In basic design, the power supply voltage, typically about 12 volts DC, is selectively applied to the air mover via an electrical path regulated by a switch. The path typically includes a number of resistances in series, e.g., at least one fuse, and usually several connectors. This path, and each segment of it, has a characteristic resistance that has the effect of reducing the voltage or current ultimately applied to the air mover. These losses tend to increase with time and wear, as resistances increase. This has the net effect that the voltage applied to the air mover often is well below the power source voltage. In an aged air temperature control system using a 12-volt battery, for example, the voltage actually applied to the air mover may only be in the range of about 9 to 10 volts or less. This causes the air mover to operate at a lower than optimal level. In the case of a fan or blower, for example, the fan or blower motor operates at lower rounds per minute (“rpm”), and the air mover correspondingly moves less air.

The approach of increasing the power source voltage often is not practical, for example, because the power source is shared by other systems and cannot be altered without affecting those systems. This approach also is disadvantageous, for example, in that it can require enhanced support systems, such as alternators, generators, distribution systems, and the like.

### OBJECTS OF THE INVENTION

Accordingly, an object of the present invention is to provide systems and methods for powering an air mover of a vehicle temperature control system that provide enhanced power to the air mover;

Another object of the invention is to provide systems and methods for powering an air mover of a vehicle temperature control system that provide efficient delivery of power to the air mover.

Another object of the invention is to provide systems and methods for powering an air mover of a vehicle temperature control system that provide increased power to the air mover without the need for increasing power system size, or capacity.

Additional objects and advantages of the invention will be set forth in the description which follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, a system is provided for powering an air mover of a vehicle air temperature control system. The air mover powering system comprises first and second power sources, and a primary path positioned between the first power source and the air mover. The primary path has a first state in which the primary path electrically couples the first power source to the air mover to apply electrical power to the air mover, and a second state in which the primary path has a lower conductivity than in the first state. Lower conductivity as used here includes a state in which the current passing through the path is lower, and not necessarily a lower conductivity in the sense of a lower inherent ability to conduct current. The system also comprises a secondary path coupled between the second power source and the air mover and which is in parallel with the primary path. The secondary path comprises a first state in which the secondary path applies supplemental electrical power from the second power source to the air mover, and a second state that has a lower conductivity than the first state of the secondary path. The provision regarding lower conductivity as noted herein above applies here as well. The system further comprises a secondary path switch operatively coupled to the secondary path and responsive to at least one of the first and second states of the primary path, wherein the secondary path switch causes the secondary path to assume the first conduction path when the primary path is in the first state, and the secondary path switch causes the secondary path to assume the second state when the primary path is in the second state.

In presently preferred embodiments, the primary path comprises a primary path switch. The secondary path switch may comprise a mechanical switching device, such as a rotating member, an electrical switching device, an electromechanical switching device such as a relay, and an electronic switching device such as an electronic relay, a solid state relay or switching transistor.

The system optionally but preferably comprises a selector for selecting at least one of the first and second states for the primary path, and optionally of the second path as well. The selector may be operatively coupled to the primary path switch, the secondary path switch, or preferably both.

The system optionally but preferably comprises a primary path state sensing means or a primary path state sensor operatively coupled to the secondary path switch. The primary path state sensing means or sensor senses at least one of the first and second states of the primary path and communicates the at least one sensed state of the primary path to the secondary path switch. The primary path state sensor may sense the state of the primary path directly, for example, where it is operatively coupled to the primary state switch or otherwise to the primary path itself. The primary path state sensor preferably is operatively coupled to the primary path to sense the state of the primary path between the primary path switch and the air mover. The primary path state sensor also may sense the state of the primary path indirectly. It may, for example, be positioned other than at the primary path, such as at the air mover.

The first state of the primary path may comprise an “on” state, and the second state of the primary path comprises an “off” state. Similarly, the first state of the primary path may comprise a “high” state. The first state of the secondary path may comprise an “on” state, and the second state of the secondary path may comprise an “off” state. The first state of the secondary path also may comprise a “high” state. The first state of the primary path may comprise an “on” state, the first state of the secondary path comprises an “on” state, and the secondary path switch may cause the secondary path to assume the “on” state when the primary path is in the “on” state. Similarly, the first state of the primary path may comprise a “high” state, the first state of the secondary path may comprise an “on” state, and the secondary path switch may cause the secondary path to assume the “on” state when the primary path is in the “high” state. Also, the second state of the primary path may comprise an “off” state, the second state of the secondary path may comprise an “off” state, and the secondary path switch may cause the secondary path to assume the “off” state when the primary path is in the “off” state. The first state of the primary path may comprise a “high” state, the second state of the primary path may comprise an “other” state that is other than the “high” state and other than an “off” state, the second state of the secondary path may comprise an “off” state, and the secondary path switch may cause the secondary path to assume the “off” state when the primary path is in the “other” state.

The second power source optionally but preferably may comprise the first power source. More preferably, the first and second power supplies are the same.

In accordance with another aspect of the invention, a system is provided for powering an air mover of a vehicle air temperature control system. The air mover powering system comprises first and second power sources, and a primary path positioned between the first power source and the air mover. The primary path has a first state in which the primary path electrically couples the first power source to the air mover to apply electrical power to the air mover. The primary path also has a second state in which the primary path has a lower conductivity than in the first state. The system also comprises a secondary path coupled between the second power source and the air mover and in parallel with the primary path. The secondary path comprises a first state in which the secondary path applies supplemental electrical power from the second power source to the air mover, and the secondary path comprises a second state that has a lower conductivity than the first state of the secondary path. The system further comprises a secondary path switch operatively coupled to the secondary path. The system still further comprises control means operatively coupled to the secondary path and responsive to at least one of the first and second states of the primary path for causing the secondary path to assume the first state when the primary path is in the first state, and for causing the secondary path to assume the second state when the primary path is in the second state. Similarly, it may comprise a controller operatively coupled to the secondary path switch and responsive to at least one of the first and second states of the primary path, wherein the controller causes the secondary path to assume the first state when the primary path is in the first state, and the controller causes the secondary path to assume the second state when the primary path is in the second state.

The primary path preferably but optionally comprises a primary path switch. The secondary path switch may comprise those forms described herein above.

The control means and/or controller according to this aspect of the invention may comprise a mechanical controller, a control circuit, a microcontroller, and the like. The control means and/or controller preferably is electrically coupled to inputs such as, for example, the primary path switch, the state selector, a manual control, one or more primary path state sensors, and the like. The control means may comprise mechanical control means for mechanically changing the state of the second path switch. The control means also may comprise electrical control means for electrically changing the state of the second path switch. The control means may and preferably does comprise a microcontroller.

In accordance with another aspect of the invention, a system is provided for powering an air mover of an air temperature control system. The air mover powering system comprises first and second power sources, and a primary path positioned between the first power source and the air mover. The primary path has a first state in which the primary path electrically couples the first power source to the air mover to apply electrical power to the air mover, and the primary path has a second state in which the primary path has a lower conductivity than in the first state. The system also comprises a secondary path coupled between the second power source and the air mover and in parallel with the primary path. The secondary path comprises a first state in which the secondary path applies supplemental electrical power from the second power source to the air mover, and the secondary path comprises a second state that has a lower conductivity than the first state of the secondary path. The system further comprises means operatively coupled to the secondary path for selecting one of the first and second states of the secondary path based upon at least one of the first and second states of the primary path.

In accordance with still another aspect of the invention, a system is provided for powering an air mover of an air temperature control system for a vehicle. The vehicle and/or the air temperature control system comprises first and second power sources and the air temperature control system comprises a primary path positioned between the first power source and the air mover. The primary path comprises a first state in which the primary path electrically couples the first power source to the air mover to apply electrical power to the air mover. The primary path has a second state in which the primary path has a lower conductivity than in the first state. The air mover powering system according to this aspect of the invention also comprises a secondary path coupled between the second power source and the air mover and in parallel with the primary path. The secondary path comprises a first state in which the secondary path applies supplemental electrical power from the second power source to the air mover. It also comprises a second state that has a lower conductivity than the first state of the secondary path. The system further comprises means operatively coupled to the secondary path for selecting one of the first and second states of the secondary path based upon at least one of the first and second states of the primary path.

In accordance with yet another aspect of the invention, a system is provided for powering an air mover of an air temperature control system for a vehicle. The vehicle and/or the air temperature control system comprises first and second power sources. The air temperature control system comprises a primary path positioned between the first power source and the air mover. The primary path comprises a first state in which the primary path electrically couples the first power source to the air mover to apply electrical power to the air mover, and the primary path comprises a second state that has a lower conductivity than the first state of the primary path. The air mover powering system according to this aspect of the invention comprises a secondary path coupled between the second power source and the air mover and in parallel with the primary path. The secondary path comprises a first state in which the secondary path applies supplemental electrical power from the second power source to the air mover, and the secondary path comprises a second state that has a lower conductivity than the first state of the secondary path. The system also comprises a controller responsive to at least one of the first and second states of the primary path, wherein the controller causes the secondary path to assume the first conduction path when the primary path is in the first state, and the controller causes the secondary path to assume the second state when the primary path is in the second state.

In accordance with another aspect of the invention, a system is provided for powering an air mover of an air temperature control system for a vehicle. The vehicle and/or the air temperature control system comprises first and second power sources, and the air temperature control system comprises a primary path positioned between the first power source and the air mover. The primary path comprises a first state in which the primary path electrically couples the first power source to the air mover to apply electrical power to the air mover. The primary path also comprises a second state that has a lower conductivity than the first state of the primary path. The air mover powering system according to this aspect of the invention comprises a secondary path coupled between the second power source and the air mover and in parallel with the primary path. The secondary path comprises a first state in which the secondary path applies supplemental electrical power from the second power source to the air mover, and the secondary path comprises a second state that has a lower conductivity than the first state of the secondary path. The system also comprises control means responsive to at least one of the first and second states of the primary path for causing the secondary path to assume the first conduction path when the primary path is in the first state, and for causing the secondary path to assume the second state when the primary path is in the second state.

In accordance with yet another aspect of the invention, a method is provided for powering an air mover of a vehicle air temperature control system. The method comprises providing first and second power sources. It also comprises positioning a primary path between the first power source and the air mover, wherein the primary path has a first state in which the primary path electrically couples the first power source to the air mover to apply electrical power to the air mover, and wherein the primary path has a second state in which the primary path has a lower conductivity than in the first state. The method further comprises positioning a secondary path between a second power source and the air mover in parallel with the primary path. The secondary path comprises a first state in which the secondary path applies supplemental electrical power from the second power source to the air mover, and the secondary path comprises a second state that has a lower conductivity than the first state of the secondary path. The method still further comprises causing the secondary path to assume the first state when the primary path is in the first conduction state, and causing the secondary path to assume the second state when the primary path is in the second conduction state.

The provision of the secondary path switch may comprise providing such switch in the forms described herein above, and below. The method optionally may comprise selecting at least one of the first and second states for the primary path using a selector, and/or selecting at least one of the first and second states for the secondary path using a selector.

The method preferably comprises sensing at least one of the first and second states of the primary path and selecting a corresponding one of the first and second states of the secondary path in response to the sensed state of the primary path. The sensing of the primary path state may comprise sensing the at least one state of the primary path at a primary path switch, for example, such as sensing the at least one state of the primary path between a primary path switch and the air mover. It also may comprise sensing the at least one state of the primary path at a position other than at the primary path, for example, such as by sensing a state of the air mover.

In accordance with still another aspect of the invention, a method is provided for powering an air mover of a vehicle air temperature control system. The method comprises providing first and second power sources. It also comprises positioning a primary path between the first power source and the air mover, wherein the primary path has a first state in which the primary path electrically couples the first power source to the air mover to apply electrical power to the air mover, and wherein the primary path has a second state in which the primary path has a lower conductivity than in the first state.

The method also comprises positioning a secondary path between a second power source and the air mover in parallel with the primary path. The secondary path comprises a first state in which the secondary path applies supplemental electrical power from the second power source to the air mover, and the secondary path comprises a second state that has a lower conductivity than the first state of the secondary path.

The method further comprises causing the secondary path to assume the first state when the primary path is in the first conduction state, and periodically monitoring the state of the primary path by causing the secondary path to assume the second state and sensing the state of the primary path. When the monitoring of the primary path indicates that the primary path is in the first state, the method comprises causing the secondary path to resume the first state, and when the monitoring of the primary path indicates that the primary path is in the second state, the method comprises causing the secondary path to assume the second state.

### BRIEF DESCRIPTION OF THE DRAWINGS

The accompanying drawings, which are incorporated in and constitute a part of the specification, illustrate a presently preferred embodiments and methods of the invention and, together with the general description given above and the detailed description of the preferred embodiments and methods given below, serve to explain the principles of the invention. Of the drawings:

FIG. 1 is a system for powering an air mover of a vehicle air temperature control system in accordance with a first presently preferred embodiment of the invention;

FIG. 2 is a system for powering an air mover of a vehicle air temperature control system in accordance with a second presently preferred embodiment of the invention;

FIG. 3 is an illustrative example of a second switch for use in the system depicted in FIG. 2;

FIG. 4 is a system for powering an air mover of a vehicle air temperature control system in accordance with a third presently preferred embodiment of the invention; and

FIG. 5 shows a timing diagram for operation of the systems shown in FIGS. 1, 2 and 4 in accordance with a presently preferred implementation of a method aspect of the invention.

### DETAILED DESCRIPTION OF THE PREFERRED EMBODIMENTS AND METHODS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

In accordance with one aspect of the invention, a system is provided for powering an air mover of a vehicle air temperature control system. The vehicle may comprise, for example, an automobile, truck, tractor, aircraft, water craft, and the like. The vehicle air temperature control system comprises a system within the vehicle or associated with it for providing temperature-adjusted or temperature-controlled air. This system typically will comprise the heating and/or air conditioning (cooling) system or environmental control system of the vehicle passenger compartment. The air mover, as noted herein above, may comprise any device or component that moves the temperature-adjusted or controlled air into, out of, or within the vehicle compartment or space. Examples of such air movers comprise a fan or blower and associated driving motor.

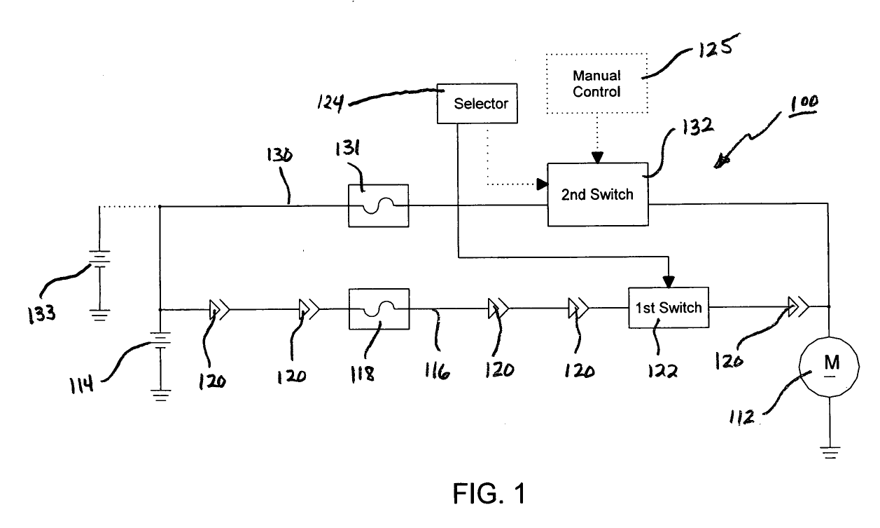

A system 100 according to a first preferred embodiment of the invention is shown in FIG. 1. System 100 is designed to power an air mover 112 of a vehicle air temperature control system (not shown) as described herein above.

System 100 comprises a first power source 114 which serves as the primary power source for the air mover. The first power source may comprise any DC voltage source capable of driving air mover 112. An example of a suitable power supply would be a 12-volt battery such as those commonly available in automobiles and trucks. Additional examples would include alternators or generators as are found in automobiles, trucks and other vehicles.

System 100 also comprises a primary or first path 116 positioned between the first power source 114 and the air mover 112 to selectively provide power to blower motor 112. As is typical in many vehicles, primary path 116 comprises a number of resistive loads in series, which in this illustrative example comprise at least one fuse 118 and a plurality of connectors 120. These loads add in known fashion to cause a voltage drop along the primary path.

Primary path 116 also comprises a primary path switch or first switch 122. This switch may comprise a relay, switching transistor, or other circuit or device capable of providing the switching functions as described herein. Switch 122 is operatively coupled to a selector 124. Operative coupling as the term is used herein means that the components are coupled during operation of the system, and may or may not be directly coupled in the sense that there may be other intervening components. Switch 124 may comprise a manual switch such as a fan control selector in the passenger compartment, an automatic fan speed selection circuit or device, or the like. It is not uncommon in modern vehicles for the temperature control system to include a solid-state controller for controlling the operations of the system, and in such systems selector 124 may comprise this air temperature control system controller.

The primary path has a first state in which the primary path electrically couples the first power source to the air mover to apply electrical power to the air mover. The primary path also has a second state in which the primary path has a lower conductivity than in the first state. This second state may constitute a zero conductivity condition, i.e., an “off” state, or it may constitute an “on” state albeit with lower conductivity (e.g., current flow) than the first state. A very low current or quiescent state would be an example.

System 100 also comprises a secondary or second path 130 coupled between a second power source and air mover 112, and in parallel with primary path 116. The secondary path comprises a first state in which the secondary path applies supplemental electrical power from the second power source to the air mover. It also comprises a second state that has a lower conductivity than the first state of the secondary path. A fuse 131 preferably is located with second path 130 to protect against over current or over voltage conditions. For reasons that will be discussed further herein below. It is desirable to keep the resistance of second path 130 as low as is practicable under the circumstances.

The second power source may comprise any power source capable of providing supplemental power to air mover 112 as generally described herein, including the forms identified herein above for the first power source. The second power source may comprise a separate power source 133 relative to the first power source 114, or it may comprise the same power source. In the presently preferred embodiments, the second power source is battery 114, i.e., the first and second power sources are one and the same.

In accordance with this aspect of the invention, the system comprises means operatively coupled to the secondary path for selecting one of the first and second states of the secondary path based upon at least one of the first and second states of the primary path. In a related aspect of the invention, the system may comprise control means, preferably in the form of a controller, operatively coupled to the secondary path and responsive to at least one of the first and second states of the primary path, for causing the secondary path to assume the first state when the primary path is in the first state, and for causing the secondary path to assume the second state when the primary path is in the second state. The selecting means and the control means may or may not comprise or constitute the same items, depending, for example, on the specific design and embodiment employed.

As implemented in system 100, these means comprise a second switch 132 disposed in the second path 130 for switching the state of the second path. Second switch 132 may comprise a mechanical switching device, for example, such as a push button switch, a pole switch, a rotating member such as a rotary selector, and the like. Switch 132 also may comprise an electrical or electro-mechanical switching device. Second switch 132, for example, may comprise a relay.

Similarly, switch 132 may comprise an electronic switching device, such as an electronic relay. Examples would include a solid state relay, a switching transistor and the like.

In system 100, the means for selecting and means for controlling the state of the secondary path 130 comprise a direct electrical connection between selector 124 and second switch 132, so that when selector 124 is used to select the “high” state on primary path switch 122, this also selects an “on” state for secondary switch 132 and secondary path 132. Selector 124 may be operatively coupled to first switch 122, or second switch 132, or more preferably both. Preferably it is capable of selecting between the first and second states for the primary and secondary paths, either directly or indirectly.

Similarly, the selecting means and controlling means preferably but optionally comprise a manual control 125 coupled directly to second switch 132 so that a system user can manually select the first state, e.g., an “on” state, for secondary switch 132 and secondary path 130. This manual control 125 may comprise, for example, a toggle switch located in the passenger compartment.

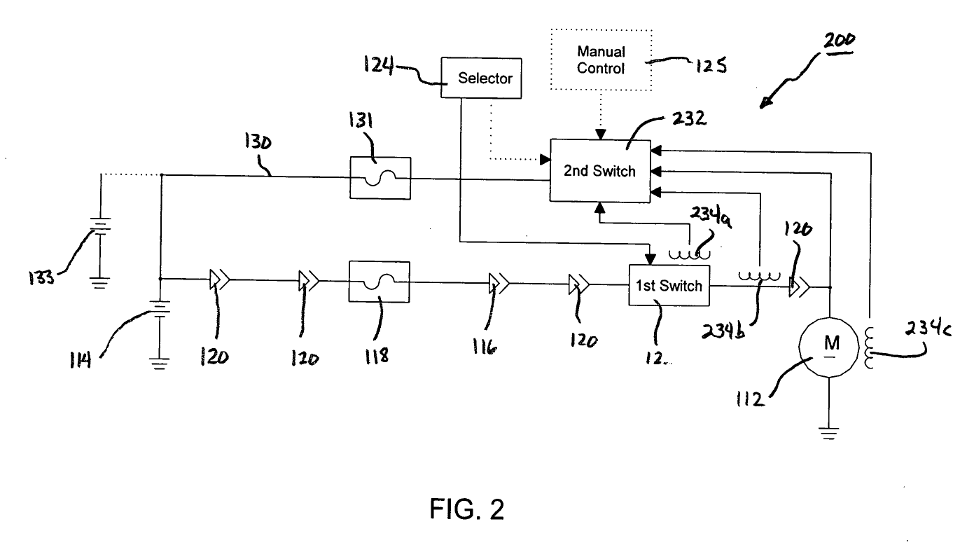

A system 200 according to a second preferred embodiment of the invention is shown in FIG. 2. System 200 corresponds to system 100 in that it comprises a power source 114, a primary path 116, one or more fuses 118, one or more connectors 120, a first switch 122, a selector 124, a manual control 125, and a secondary path 130, all as described herein above. System 200 also comprises the selecting means and control means as identified herein above, which in this embodiment comprises a second switch 232 that may or may not be the same as second switch 132. This is described further herein below. The primary and secondary paths also have first and second states as described herein.

System 200 further comprises primary path state sensing means operatively coupled to the secondary path switch for sensing at least one of the first and second states of the primary path and communicating the at least one sensed state of the primary path to the secondary path switch. The primary path state sensing means preferably comprises at least one primary path sensor, positioned to sense, directly or indirectly, the state of the primary path. The primary path state sensor may sense any one or combination of a number of states or phenomena. Preferred direct measurement regimes comprise, for example, measuring the current in the primary path, the voltage of the primary path, the power dissipation, etc.

The measurement approach may be direct, for example, in which the state of the primary path is measured directly, or indirect, for example, in which the measurement is not directly of the primary path itself but of a phenomena or measurement quanta that corresponds with, or is reflective or indicative of, the state of the primary path. With direct sensing, it is possible to position one or more sensors at any location along the primary path. A presently preferred but merely illustrative example of a direct measurement regime would comprise operatively coupling the sensor to the primary path switch so that the state of the primary path is sensed and thus ascertained from the state of the primary path switch. Another example of a direct measurement regime would be where the primary path state sensor is operatively coupled to the primary path to sense the state of the primary path between the primary path switch and the air mover.

Indirect measurement comprises positioning the primary path state sensor other than at the primary path, or making something other than a direct measurement of the primary path state. Preferred indirect measurement approaches include, for example, positioning one or more primary path state sensors at the air mover, e.g., to measure the current, voltage and/or power at the motor. Another illustrative indirect measurement technique includes positioning one or more sensors, in the form, for example, of one or more air flow sensors, at the output of the air mover to measure the air flow resulting from the air mover operation. The air flow sensor may comprise a sensor for measuring or detecting air speed, air volumetric flow rate, pressure, and other means for sensing the state of the air mover.

As implemented in system 200, a primary path switch sensor 234a is operatively coupled to primary path switch 122 and responsive to it so that, when the state of primary path switch 122 is set or changed, that setting or change is communicated to secondary path switch 232 via sensor 234a so that secondary path switch 232 causes the appropriate setting or change in setting for the secondary path 130.

A primary path state sensor 234b in the form of a current sensor also is provided in primary path 116 between primary path switch 122 and air mover 112. Current sensor 234b senses the current in primary path 116, and thus measures its conduction, and communicates this state to second switch 232. Switch 232 then switches the state of the secondary path 130 as desired in response to or based upon this sensed primary path state.

In addition or, again, alternatively, an air mover sensor 234c in the form of an air flow sensor is positioned at air mover motor 112. This air mover sensor 234c senses the air flow output of air mover 112 and communicates this measurement to secondary path switch 232, upon which secondary path switch 232 is used to set or control the state of the secondary path in response.

Primary path state sensors generally, and sensors 234a, 234b and 234c collectively, are referred to herein as sensors 234.

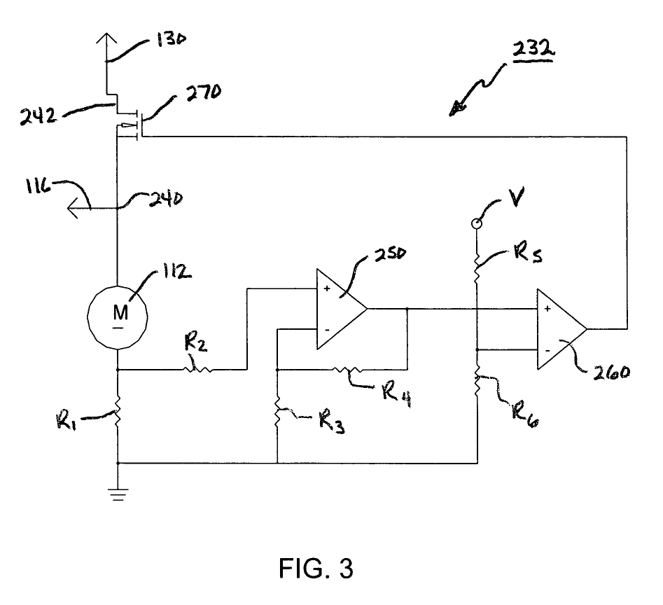

Switch 232 may be the same as or different from switch 132. It may be different, for example, in that it must be compatible with the first path sensing means and other components of system 200 that may not be present in system 100 or may not be identical to those of system 100. An example of a switch 232, in the form of an analog electrical switch, is shown in FIG. 3 and will now be described. Switch 232 is coupled to primary path 116 at a point 240, and to secondary path 130 at a point 242. It also is coupled to air mover motor 112. A current sense resistor R1 is connected between one pole of motor 112 and ground. This resistor R1, which also may comprise a part of sensor 234c, senses the electrical current across motor 112. It preferably develops a very small voltage drop across it as current passes through and out of motor 112. A resistor R2 is coupled to the output of the motor 112 above resistor R1. Resistor R2 is coupled at its other end to the positive terminal of an operational amplifier (“op amp”) 250. The negative terminal of op amp 250 is coupled to ground via a resistor R3. Resistors R3 and R4 preferably have the same resistive value so they serve to balance the inputs of op amp 250. The negative terminal of op amp 250 is coupled to its own output terminal via a resistor R4. The output of op amp 250 also is coupled to the positive terminal of a second op amp 260. The negative terminal of op amp 260 is coupled to the bridge of a voltage divider formed by or comprising resistors R5 and R6. Resistor R5 is provided with a supply voltage V, and resistor R6 is coupled to ground at its distal end. The output of op amp 260 is coupled to the gate of a metal oxide field effect transistor (“MOSFET”) 270. Secondary path 130 is coupled at point 242 to the distal end of the conduction path of MOSFET 270. The proximal end of the conduction path of MOSFET 270 is coupled to primary path 116 and to the terminal of motor 112 distal from resistor R1.

In operation, resistor R1 functions as a current sensor. The voltage drop created by it as current passes through motor 112 is fed to and multiplied by op amp 250, which functions essentially as a voltage multiplier. The output of op amp 250 is fed to op amp 260, which functions as a comparator and threshold detector. The voltage at the negative terminal of op amp 260 V_{neg} is:

$${V}_{neg} = \frac{{R}_{6}}{( {R}_{5} + {R}_{6} )}$$

This voltage V_{neg} serves as a threshold. If the multiplied voltage at the positive terminal of op amp 260 is greater than the reference voltage V_{neg} on the negative terminal of op amp 260, then system 200 and primary path 116 are assumed to be in the first (“on” or “high”) state. When this occurs, op amp 260 provides an output voltage to the gate of MOSFET 270, which closes the second path 130 and applies supplemental power from battery 114 to motor 112.

In the presently preferred embodiment, and in the specific application of an automotive heating and air condition system operating with a 12-volt battery, preferred values for the resistors comprise the following:

| | Resistor | | | | | |
|---|---|---|---|---|---|---|
| | R1 | R2 | R3 | R4 | R5 | R6 |
| Value | 2 milli- | 1 | 1 K-ohms | 47 | 4.7 K-ohms | 3.9 |
| | ohms | K-ohms | | K-ohms | | K-ohms |

K-ohms = kilo-ohms

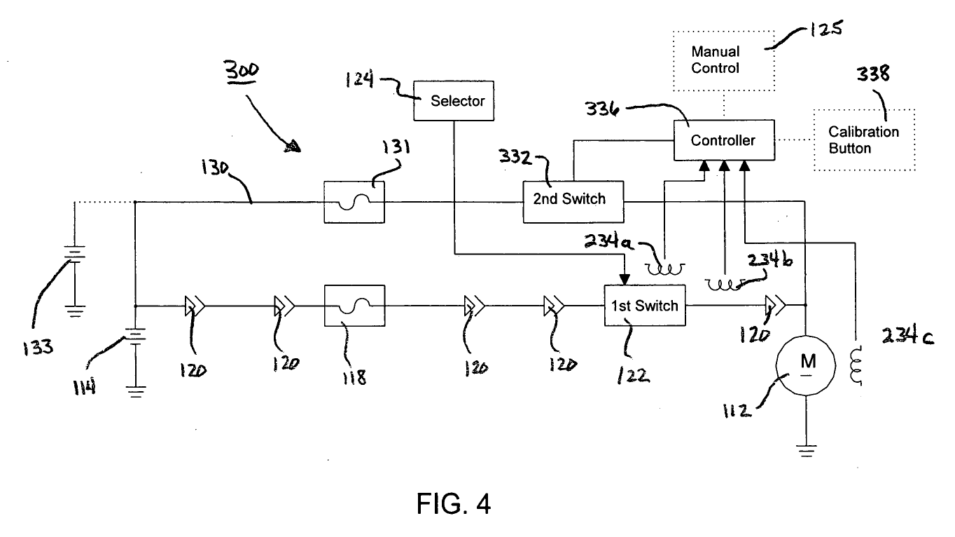

A system 300 according to a third preferred embodiment of the invention is illustrated in FIG. 4, and will now be described. System 300 is identical to systems 100 and 200 in many of its components, and such like components are identified in FIG. 4 by like reference numerals. System 300 comprises an air mover 112 comprising a blower with motor operatively coupled to a first power source, such as a battery 114. A primary path 116 selectively and operatively couples battery 114 to blower motor 112. Primary path 116 comprises at least one fuse 118, connectors 120, and a first switch 122. Selector 124 is operatively coupled to switch 122. System 300 also comprises a second conduction path 130 in parallel with primary path 116. A second switch 332, which may be the same as or different from switches 132 and 232, is disposed in second path 130 as described above for systems 100 and 200. Sensors 234 also are provided.

In system 300, the means for selecting one of the first and second states of the secondary path based upon at least one of the first and second states of the primary path, and the control means for causing the secondary path to assume the first state when the primary path is in the first state and for causing the secondary path to assume the second state when the primary path is in the second state, comprise a controller which, in this embodiment, comprises a microcontroller 336 appropriately programmed to perform the functions as described herein. In this presently preferred but illustrative embodiment, microcontroller 336 comprises a PIC 12F675 microcontroller, commercially available from Microchip Technologies, Inc. of Phoenix, Ariz. The microcontroller optionally may be programmable, and may be wirelessly programmable. In the latter instance, it may employ a wireless programming capability, for example, as disclosed in the assignee UnwiredTools, LLC's co-pending U.S. patent application Ser. Nos. 10/897,325 and/or 10/921,790, the complete specifications of which are hereby incorporated by express reference.

Microcontroller 336 is operatively coupled to and receives as inputs from the primary path state sensing means, e.g., one or more, and preferably all, of the primary path state sensors 234a, b and c. Thus the microcontroller receives as an input data indicative of the state of the primary path via these sensors. Microcontroller 336 also may be operatively coupled to selector 124 so that the output or state of state selector 124 is an input to the microcontroller. Microcontroller 226 also is operatively coupled to and receives inputs from manual control 125.

In addition, microcontroller 336 is operatively coupled to and outputs signals to secondary path switch 332. Switch 332 may be essentially the same as switch 232, but should be compatible with the microcontroller 336 and its operating parameters and requirements.

Accordingly, when microcontroller 336 receives a signal from current sensor 234b, for example, indicating that the current state on primary path 116 is at or above a threshold current, microcontroller 336 causes second switch 332 to apply supplemental power to blower motor 112, for example, by closing the circuit path 130 to electrically couple battery 114 and/or 133 to motor 112. Conversely, when microcontroller 336 receives a signal from current sensor 234b indicating that the current state on first path 116 is below a threshold current, microcontroller 336 causes second switch 332 to remove supplemental power from blower motor 112, for example, by opening the circuit path 130 between battery 114 and/or 133 and motor 112. Microcontroller 336 also may be adapted to respond to an input from selector 124 by influencing the state of switch 332 in response to the input from selector 124. For example, microcontroller 336 may cause switch 332 to open if selector 124 is set to turn the blower motor 112 to a lower setting, independently of or overriding the state of the primary path 116, or it may cause switch 332 to enhance the current through the secondary path 130 if selector 124 is moved to a higher setting. It is also possible to control the state of second switch 332 using microcontroller 336 where it is responsive only to selector 124, rather than to sensors 234, for example, as a manual override.

In accordance with another aspect of the invention, a method is provided for powering an air mover of a vehicle air temperature control system. For simplicity and ease of illustration, a presently preferred implementation of the method will now be described with reference to systems 100, 200 and 300. It should be appreciated, however, that the method is not necessarily limited to these preferred but illustrative systems, and may be practiced with other systems, components, configurations and environments.

This preferred method implementation comprises providing first and second power sources. A preferred first power source would include those identified herein above, an example of which includes battery 114. Preferred second power sources also are as described herein above. The second power source may be different from the first power source, but preferably comprises the first power source, and more preferably the two are one and the same.

The preferred method implementation also comprises positioning a primary path, such as path 116, between the first power source and the air mover, such as air mover 112. The primary path preferably but optionally comprises a first switch, such as switch 122. The primary path has a first state in which the primary path electrically couples the first power source to the air mover to apply electrical power to the air mover, and the primary path has a second state in which the primary path has a lower conductivity than in the first state.

The preferred method implementation further comprises positioning a secondary path between a second power source and the air mover in parallel with the primary path. Preferably this comprises positioning secondary path 130 between battery 133, or more preferably battery 114, and air mover 112 in parallel with the primary path. The secondary path comprises a first state in which the secondary path applies supplemental electrical power from the second power source to the air mover, and a second state that has a lower conductivity than the first state of the secondary path.

The preferred method implementation further comprises causing the secondary path to assume the first state when the primary path is in the first conduction state, and causing the secondary path to assume the second state when the primary path is in the second conduction state. Although this aspect of the method may take a number of forms, it preferably comprises commonly controlling the two paths, e.g., using selector 124. More preferably, however, it comprises monitoring the state of the primary path, for example, using sensing means such as one or more of the sensors 234 or the like, and using a control means such as switch 132 or 232, or microcontroller 336 and switch 332 to set the state of the secondary path based upon the sensed state of the primary path.

To provide an illustrative example of this method, its implementation using each of the presently preferred system embodiments 100, 200 and 300 will be described. Prior to that description, however, some general comments regarding the “states” of the primary and secondary paths would be helpful.

In the presently preferred embodiments and methods, the state of the second path, for example, its conduction state (i.e., the amount of current passing through the path) is controlled in response to, or in some form of correlation with, the state of the primary path. The primary path normally will have at least two states, i.e., an “on” state and an “off” state. In many vehicle air temperature control systems, the air mover will have a number of “on” states, ranging from relatively low fan speeds to a “high” speed or setting. The system may be designed, for example, such that the primary path has two tiers, i.e., a low tier and a high tier, with multiple fan speed settings in each tier.

The second path similarly will normally have at least two states, i.e., an “on” state and an “off” state. It is possible, however, for the secondary path to have a plurality of “on” states, e.g., as with the primary path, ranging from a “low” state to a “high” state. For each of the primary and secondary paths, it is possible for the state, such as the conduction state, rather than being “off” in an absolute sense (e.g., 0 amps), to be at a very low level that, while not technically off, is at a quiescent or non-operational level.

In the presently preferred systems and methods, the “first” state of the primary path corresponds with a state of that path at which it is desired for the secondary or supplemental path to assume an “on” state. Although the primary path may have only two states (“on” and “off”), it more typically will have multiple “on” states. Therefore, in the presently preferred embodiments and methods, the “first” state of the primary path corresponds either to the “high” state for the primary path, or to the highest tier or set of states.

The “on” state of the secondary path, as noted, may comprise a single “on” state, or it may assume one or more of a plurality of possible “on” states. The control means also may be adapted to select from among multiple secondary path states, depending, for example, on a single sensor input (e.g., sensor 234a) or multiple inputs (e.g., sensors 234 and selector 124. This selection may or may not involve algorithms or processing from among the sensor inputs based on predetermined programs or logic. Such algorithms or processing would depend upon the specific application and desired system characteristics. The second path, for example, may be provided with a number of states equal to those of the primary path, so that there can be a one-to-one correspondence and correlation.

Within this framework, there are a number of possibilities or options for the relationships of the states for the primary and secondary paths. In a relatively simple system, for example, the first state of the primary path may comprise an “on” state, and the second state of the primary path may comprise an “off” state. Where the primary path has multiple “on” states, the first state of the primary path may and preferably would comprise a “high” state, or a high set or tier of states. Again, in relatively simple embodiments and implementations, the first state of the secondary path may comprise an “on” state, and the second state of the secondary path may comprise an “off” state. Where the second path can assume multiple “on” states, the first state of the secondary path preferably but optionally could comprise a “high” state that is used when extra capacity is needed or desired.

In correlating the states of the primary and secondary paths, where the first state of the primary path comprises an “on” state and the first state of the secondary path comprises an “on” state, the secondary path switch preferably causes the secondary path to assume the “on” state when the primary path is in the “on” state. Where the first state of the primary path comprises a “high” state and the first state of the secondary path comprises an “on” state, the secondary path switch preferably causes the secondary path to assume the “on” state when the primary path is in the “high” state.

As for deactivating or downwardly adjusting the state of the secondary path, when the second state of the primary path comprises an “off” state, preferably the second state of the secondary path comprises an “off” state and the secondary path switch causes the secondary path to assume the “off” state when the primary path is in the “off” state. Where, for example, the primary path has multiple “on” states, including a “high” state, it is preferable that the second state of the primary path comprises an “other” state that is other than the “high” state and other than an “off” state, whereupon the second state of the secondary path preferably comprises an “off” or quiescent state, and the secondary path switch causes the secondary path to assume the “off” state when the primary path is in the “other” state.

Turning now to the preferred method as implemented using the first preferred embodiment, when system 100 is in its “off” state, primary path 116 and secondary path 130 are in the “off” state, and are non-conductive. During this “off” state of the system, selector 124 will be in its “off” position or state, and switches 122 and 132 will be in their second or preferably their “off” or quiescent states, i.e., the switches will be in an “open” state so that first path 116 and second path 130 are non-conductive as it relates to blower motor 112.

When system 100 is turned on, for example, using selector 124, but wherein a fan speed lower than the “high” state is selected, primary path 116 assumes one of several of its “on” states, and current is conducted through primary path 116 from battery 114 to fan motor 112. Second switch 132 remains open so that secondary path remains non-conductive.

If selector 124 is changed to select the “high” fan speed, this is communicated to first and second switches 122 and 132. This causes first switch 122 to increase the current, conductivity and/or power delivery in primary path 116. It also causes switch 132 to close, thereby changing secondary path 130 from an “off” or quiescent state to an “on” state. This creates a parallel path between the power source or sources and the air mover relative to primary path 116. This lowers the net or effective resistance of the circuit between the power supply or supplies and the air mover, which results in supplemental power being delivered to the air mover relatively to use of the primary path alone.

Similarly, if manual control 125 is actuated, this causes switch 132 to close secondary path 130 to apply supplemental power to air mover 112.

The operation of preferred system 200 is very similar to that of system 100. With system 200, however, one or more sensors 234 can be used to control the switching of the secondary path, instead of or in addition to selector 124 and/or manual control 125.

System 200 is in the same state as system 100 during its “off” or quiescent stage. When system 200 is activated, but only at a level sufficient to call for operation of the primary path and not of the secondary path, e.g., using selector 124, power is delivered from battery 114 via the primary path 116, as described herein above for system 100.

In this embodiment, however, as noted, switching of secondary path 130 can be done using one or more of the sensors 234. The secondary path can be switched to an “on” state, for example, when such state is indicated by selector 124 or manual control 125 directly to second switch. The secondary path also can be switched to an “on” state, however, when the primary path goes to a first state. This may comprise, for example: (a) an indication from first switch 122 via sensor 234a that primary path 116 has entered the “high” state, (b) a predetermined or threshold current has occurred in the primary path 116, e.g., as measured by sensor 234b, (c) a predetermined or threshold fan speed or air flow value has been detected, e.g., as measured by sensor 234c, and/or the like. In system 200, sensor 234 also may sense the change of current in first path 116 and provide a corresponding signal to second switch 232. The first state of the primary path may be deemed to arise when any one or combination of these has occurred. In other words, each of these, or any of these, may be deemed a “triggering event” that triggers the setting of the first state in the secondary path 130.

When such a triggering event occurs, second switch 232 receives the signal from the respective selector or sensor, and responds by setting or otherwise causes the first state of the secondary path to be set. In this embodiment, this involves applying a signal to a gate or control portion of secondary switch 232, which causes it to close secondary path 130 to apply supplemental power from battery 114 and/or battery 133 to air mover 12.

A preferred but merely illustrative example of the method according to this aspect of the invention will now be described as it is implemented in system 300. System 300 is similar to system 200, but adds a controller in the form of microcontroller 336. Its preferred operation is very similar to that described herein above for system 200, but differs in the use of the microcontroller operating in conjunction with second switch 332. Operation of system 300 when the secondary path 130 is not actuated (while it is in its “off” or quiescent state) is essentially the same as that for systems 100 and 200, as described above.

When a triggering event calls for the activation or setting of the state of the secondary path to a first state, e.g., an “on” state, it occurs somewhat differently than in system 200. In this embodiment, selector 124, manual control 125, and one or more of the sensors 134 are coupled to microcontroller 336 and provide respective signals as inputs to this microcontroller. Microcontroller 336 monitors the inputs from these devices. When the input from one of these devices indicates, based on a program or logic in microcontroller 336, that the state of secondary path 130 should be changed, for example, from an “off” state to an “on” state, or from a given “on” state to a different “on” state, e.g., to a higher or lower state, microcontroller 336 generates an output to second switch 332 that causes switch 332 to place secondary path 130 in the desired new state. This may be accomplished, for example, by closing switch 332 to create a conductive electrical path from battery 114 to air mover 112 and thus apply the supplemental power to the air mover. It also may be accomplished, for example, by performing a gating function, to regulate the conductivity or resistivity of the current path through switch 332. The amount of current or power delivered to air mover 112 via second path 130 thus may be regulated. The use of a microcontroller offers added flexibility and other advantages, e.g., such as a more robust control, priority of switching, etc.

The selective use of the secondary path to provide supplemental power as is afforded in each of the presently preferred embodiments and method implementations as described herein can significantly increase the efficiency and capabilities of the air temperature control system. When power is delivered only through the primary path 116, for example, (i.e., the second path is in an “off” state”), the amount of power actually applied to blower motor 112 usually is lower than the power available at the battery 114. This is attributable to the losses and corresponding voltage drops associated with the series resistances in primary path 116. These resistances typically include, for example, the line resistance, resistance associated with fuse or fuses 118, resistances associated with connectors 120, the line losses, and the like. Because these resistances are in series, they are additive:
R_{system}=R₁+R₂+R₃+ . . .
If battery 114 is a standard 12-volt automotive battery, for example, the voltage actually applied at blower motor 112 using only primary path 116 typically would be in the range of 9 to 10 volts. This power loss typically gets worse as the system ages and wears, e.g., as components wear, corrode, loosen, and the like.

When primary path 116 and second path 130 are used together to provide a parallel circuit between battery 114 and blower motor 112, significantly greater amounts of power can be delivered to the air mover. Because the paths are in parallel, the total resistance of the system is the inverse ratio of the resistance of each path:

$$\frac{1}{Rsystem} = \frac{1}{R 1} + \frac{1}{R 2} + \frac{1}{R 3} + …$$

This total resistance is well below the series resistance of primary path 116 alone. This is particularly true where the second path is configured to have very low resistance relative to path 116. Thus, by adding the second path and configuring it in a parallel arrangement, the total resistance of the system can be reduced well below that of a single path series system. This increases the power available to the air mover for a given power source without having to provide a larger power supply, an additional power supply, and the like. In a typical vehicle air temperature control system using a standard 12-volt battery, for example, systems such as systems 100, 200 and 300 typically would provide about 12 volts to the air mover. This represents an approximately 45% to 75% improvement in power availability with the same power source.

In each of these embodiments, it is necessary or desirable to set a threshold value or level of operation at which the secondary path is to be activated, i.e., when it is to enter the “first” state. Below this threshold, the secondary path preferably is in its “second” state, e.g., its “off” or quiescent state. At or above the threshold, for example, the system causes the secondary path to become conductive. The task of setting the threshold level in essence becomes one of selecting the threshold value or range of values for the measured quantity or quantities (e.g., current, voltage, etc.) at which it is desirable for the secondary path to become activated within desired reliability and precision in the inherently transient environment.

As will be appreciated from the foregoing description, second path 130 is switched in general correlation with the state of the primary path 116, so that their states generally correspond. Given the transient nature of the system, i.e., the periodic need to change the blower speeds or to turn the blower on or off, it is necessary or at least desirable for the air mover power control system to accommodate these transient states. As was noted herein above, when first path 116 is changed from an initial “second” state to its “first” state, and this is detected through sensors 234, switch 332 causes second path 130 to become conductive, as described herein above. To avoid false positive readings on sensors 234 that would otherwise result in mistakenly switching second path 130 to a conductive state, the monitoring and switching arrangement of the presently preferred systems as described herein preferably requires that the current sensed at or for primary path 116 be at least a threshold value.

One method for setting this threshold value is to place the primary path in the state at which it is desired for the supplemental power to be applied, and then to set the threshold value at that state. For example, one may use the manual selector 124 to set the blower speed to its “high” of full power position, and then to set the threshold value at the value corresponding to this “high” state. This can be accomplished, for example, using a calibration device such as a calibration button 338 operatively coupled to the controller, e.g., as shown in FIG. 3. Depression of this button 338 causes the measured value sensed at sensors 234 to be stored in the controller (e.g., microcontroller 336) as the threshold value. Once thus stored, this threshold value can be compared to measurements of the primary path at sensor 234 to determine whether the primary path is operating at its “high” state. In these systems, for example, the threshold value preferably would be about 10 amperes (amps). As noted above, the state of primary path 116 similarly may be monitored using its voltage level as well. One also may impose other requirements, for example, that the sensed current or voltage be sustained at or above this threshold value for a minimum time period. Preferably, only if the threshold value is met or exceeded and the thresholding requirements are met does the system render second path 130 conductive.

Systems such as systems 100, 200 and 300 also preferably include the ability to limit or open the second path 130 when the conductive state of the primary path 116 is reduced or turned to the “second” state. This can be accomplished according to another aspect of the invention, wherein the state of the primary path is monitored and, when a change to a lower state of conductivity is detected, the state of the second path is changed correspondingly to decrease its conductive state, e.g., to turn it to its “off” or quiescent state.

One way of accomplishing this is to monitor the current on primary path 116 using one or more sensors, such as sensors 234, and when the sensed current drops below a lower threshold value, switch 132, 232, 332, preferably but optionally operating under the control of a controller or microcontroller such as microcontroller 336, causes the conductive state of second path 130 to be adjusted to its “second” state to correspond to the lower conductive state of primary path 116. If the current on first path 116 as sensed by sensor 234b goes below 5 volts, for example, second switch 332 may then cause second path 130 to be opened and thus render it non-conductive or “off.”

It is not uncommon for the state of the primary path to fluctuate or experience transients, as has been noted herein above. In some instances, particularly where the power reduction threshold values are high or are tightly spaced, it is possible that the system could mistakenly misinterpret a negative current, voltage or power transient as an intended transformation in primary path back to its second state, and mistakenly adjust the second path to its second state, e.g., to its “off” state. In accordance with another aspect of the invention, a method is provided that allows for reliable state selection while avoiding or eliminating this type of generally undesirable phenomena.

The method comprises providing first and second power sources, and positioning a primary path between the first power source and the air mover. The primary path has a first state in which the primary path electrically couples the first power source to the air mover to apply electrical power to the air mover, and a second state in which the primary path has a lower conductivity than in the first state, as previously described. The method also comprises positioning a secondary path between a second power source and the air mover in parallel with the primary path, wherein the secondary path comprises a first state in which the secondary path applies supplemental electrical power from the second power source to the air mover, and a second state that has a lower conductivity than the first state of the secondary path, also as previously described.

This method further comprises causing the secondary path to assume the first state when the primary path is in the first state, and periodically monitoring the state of the primary path by causing the secondary path to assume the second state and sensing the state of the primary path. When the monitoring of the primary path indicates that the primary path is in the first state, the method comprises causing the secondary path to resume the first state. When the monitoring of the primary path indicates that the primary path is in the second state, the method comprises causing the secondary path to assume the second state.

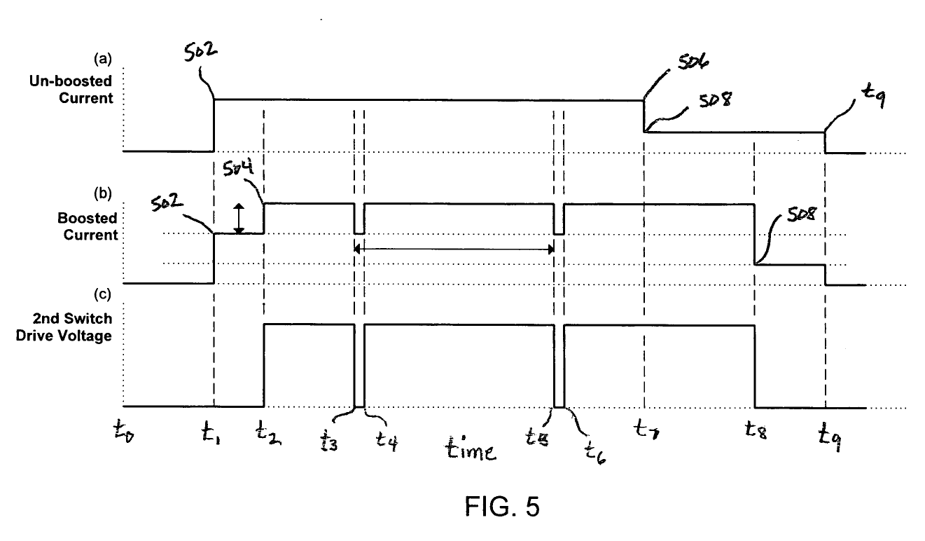

A presently preferred but merely illustrative implementation of this method will now be described with reference to FIG. 5, and using for illustrative purposes system 300 as shown in FIG. 3. In this implementation, second path 130 is periodically effectively removed from the system for a brief period, during which the state of primary path 116 alone is measured. This masks or removes the effect of the second path 130 on the system and permits the state of primary path 116 alone to be measured. This primary path state measurement then is indicative of the selected or intended state of the primary path, without the effects of the second path, e.g., without the effects of the supplemental power provided by second path 130. If the state of the primary path 116, measured independently of the second path 130, is at or below a lower threshold value, the system takes this as an indication that the desired air mover speed or state is lower, or “off,” and the second path then is adjusted accordingly, i.e., to its second state.

FIG. 5 is a timing diagram, wherein the x-axis denotes time. The upper time line (a) represents the unboosted current in the primary path 116, e.g., at sensor 234b. This is the current that would be seen if the system were operated without use of secondary path 130, i.e., without the supplementary power provided through the use of secondary path 130, assuming as we do here that primary path 116 is the only path providing power to air mover 112. In this configuration, resistive losses occur as described above, and the power applied to air mover 112 is correspondingly reduced relative to that available from battery 114. Center time line (b) represents the boosted current using secondary path 130, i.e., when system 300 is fully functional with both primary path 116 and secondary path 130, and wherein secondary path 130 is selectively made conductive and in parallel with primary path 116 as further described herein below. Bottom time line (c) represents the drive or gate signal (here a voltage signal) that is used to switch secondary path 130. This signal provides an example of the driving or gate voltage that would be applied to the gate of second switch 332, presuming that switch comprises a gated transistor switch.

At time t₀, system 300 is in the “off” state, wherein both primary path 116 and secondary path 130 are in their “second,” and in this example, “off,” state. At time t₁, the system user uses selector 124 to turn the system “on” and to select the “high” state. In response, first switch 122 closes primary path 116 and applies power from battery 114 to air mover 112. The unboosted current associated with this selection, as reflected at 502 in time line (a), in the preferred but illustrative system 300 might be, for example, 10 amps. This current is sensed, for example, at sensor 234b, and the sensor in turn provides a signal comprising this information to microcontroller 336. Microcontroller 336 responds by issuing a signal to second switch 332 causing it to close second path 130, thereby forming a parallel circuit with primary path 116 between battery 114 and air mover 112. This occurs at time t₂. The turning on of switch 332 is shown in timeline (c) beginning at time t₂. Typically there is a time lag between the closing of primary path 116 and the closing of secondary path 130. This time lag in this illustrative example is shown in time line (b), between time t₁ and time t₂. As secondary path 130 enters its first state and becomes conductive, the net current at air mover 112 is greater than the corresponding unboosted current. In this illustration, the current at air mover 112 would be about 15 amps (reference numeral 504), for example, as opposed to the unboosted 10-amp level (numeral 502).

At a desired and preferably predetermined time after the secondary path 130 has been in its conductive state, for example, at time t₃, microcontroller 336 causes second switch 332 to open secondary path 130, and to keep it open for a desired sampling period Tₛₐₘₚₗₑ, here extending from time t₃ to time t₄. As a result, if primary path 116 continues to be in its first state (here its “high” state), path 116 again becomes the sole conductive path and the current within it correspondingly increases, normally to its unboosted level of about 10 amps. Alternatively, however, if during this or the preceding period since the last sampling, the system has been changed from its “high” state, the current in primary path 116 would be at a lower level, and if the system has been turned “off,” at a zero level. Because it is common to have transient variations in the current level, it is desirable to set a threshold level above which the system is assumed to be “on” and the primary path 116 is assumed to be in its first or “high” state, and below which the system is assumed to be at its second, i.e., lower or “off” state.

Accordingly, during sampling period Tₛₐₘₚₗₑ, current sensor 234b is used to sample the current in path 116 and report this measured quantity to microcontroller 336. Microcontroller 336 compares this measured quantity to the threshold. If the sensed signal from sensor 234b is at or above the threshold level, microcontroller 336 reads this as indicating that the system is still intended to be in its “high” state. Microcontroller 336 in response closes second switch 332, whereupon secondary path 130 once again becomes conductive and the current at air mover 112 again goes to its boosted level of about 15 amps. This occurs in this example at time t₄. The system then continues for the remainder of the duty cycle T_{DC}, which in this example continues until time t₅.

If during this process the current sensed by sensor 234b and reported to microcontroller 336 during a sample period Tₛₐₘₚₗₑ is at or near zero (the “second” state for primary path 116), microcontroller 336 reads this as an indication that the system has been changed from its “high” state to a lower (“second”) state. In response, microcontroller 336 continues to maintain second switch 332 in its open state and thus keeps second path 130 in its second or “off” state.

This process of opening the secondary path 130, sampling the current, and responding continues until the second or “off” state is encountered. To illustrate a circumstance in which this occurs, at time t₇ the system user uses selector 124 to turn the system to a “low” state wherein the air mover 112 is at a low speed but is not off. As shown in time line (a), the unboosted current corresponding with this state falls from the “high” state level of about 10 amps (reference numeral 506) to a level below the “high” state (reference numeral 508), e.g., here at about 3 amps. At this time t₇, the system is not in its sampling period, so second path 130 continues to be “on” and conductive. When the next sampling period Tₛₐₘₚₗₑ starts at time t₈, current sensor 234b senses and microcontroller 336 thus detects this lower current level 508, and terminates the gate signal (time line (c) at t₈). This causes the total or net current to drop to the unboosted level corresponding to level 508, here about 3 amps.

At time t₉, the system user uses selector 124 to turn the system to its “off” state. This is communicated to first switch 122, which opens to render primary path 16 non-conductive. Because secondary path 130 is already in its non-conductive state, this causes the total current to go to zero.

The parameters of this procedure, for example, such as the duration of the duty cycle T_{DC}, the sampling time, etc. may vary from system to system and application to application, depending, for example, upon the particulars of the system, the desired robustness of the system, etc. In the presently preferred embodiments shown and described here as systems 100, 200 and 300, when implemented in an automotive heating and air conditioning system operating with a standard 12-volt battery, for example, a 1 to 3-second duty cycle T_{DC} with a 10- to 50-millisecond sample time Tₛₐₘₚₗₑ are preferred. The sampling period Tₛₐₘₚₗₑ preferably will be in the range of about 1% to 10% of the duty cycle T_{DC}. These time periods may be shorter, provided they do not become so short that the system is unduly adversely impacted, e.g., where the sampling period overlaps with the relaxation or response time of the circuitry, the air blower motor, etc. A sampling time of as little as 5 milliseconds is possible, for example, with many automotive environmental control systems. These time periods also may be longer. Lengthening them unduly, however, can result in the secondary path 130 being closed and the air mover operating for an unacceptable time after turning the system down or if in some cases. As specifically implemented in the presently preferred systems 100, 200 and 300, for example, it is preferred that they use a 1-second duty cycle T_{DC} with a sampling time Tₛₐₘₚₗₑ of about 5 to 10 milliseconds.

It should be noted that where it has been described herein that measurements are taken and communicated, for example, with sensors 134, 134a and 134b, this may comprise taking absolute measurements and communicating those absolute measurements to the switch, microcontroller, etc. This is not, however, necessarily limiting. The taking of the measurement itself may comprise merely detecting whether a particular state is in existence, or whether a threshold has been met. It also may comprise, for example, taking a measurement and then communicating only a single bit of date, e.g., indicating whether a threshold value has been reached, or communicating only a limited subset of data for the measurement, for example, such as offsets from one or more threshold values.

As has been noted herein above, the invention comprises various aspects. The system according to one aspect comprises the primary path, secondary path, power source and state setting apparatus, as described herein above. A system according to a related aspect of the invention may include only the secondary path and state setting apparatus for the secondary path, for example, as a kit for use with a vehicle that already includes the power source and primary path.

Additional advantages and modifications will readily occur to those skilled in the art. For example, although the illustrative embodiments, method implementations and examples provided herein above were described primarily in terms of the conductivity or current state of the conduction paths, one also may monitor or control voltage states, power states, combinations of these, and the like. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

What is claimed is:

1. A system for powering an air mover of a vehicle air temperature control system, the air mover powering system comprising:
first and second power sources;
a primary path positioned between the first power source and the air mover, the primary path having a first state in which the primary path electrically couples the first power source to the air mover to apply electrical power to the air mover, and the primary path having a second state in which the primary path has a lower conductivity than in the first state;
a secondary path coupled between the second power source and the air mover and being in parallel with the primary path, the secondary path comprising a first state in which the secondary path applies supplemental electrical power from the second power source to the air mover, and the secondary path comprising a second state that has a lower conductivity than the first state of the secondary path; and
a secondary path switch operatively coupled to the secondary path and responsive to at least one of the first and second states of the primary path, wherein the secondary path switch causes the secondary path to assume the first conduction path when the primary path is in the first state, and the secondary path switch causes the secondary path to assume the second state when the primary path is in the second state.

2. A system as recited in claim 1, further comprising a primary path state sensor operatively coupled to the secondary path switch.

3. A system as recited in claim 1, further comprising primary path state sensing means operatively coupled to the secondary path switch for sensing at least one of the first and second states of the primary path and communicating the at least one sensed state of the primary path to the secondary path switch.

4. A system as recited in claim 1, wherein:
the first state of the primary path comprises a “high” state.

5. A system as recited in claim 1, wherein the second power source comprises the first power source.

6. A system as recited in claim 1, wherein the first and second power supplies are the same.

7. A system for powering an air mover of a vehicle air temperature control system, the air mover powering system comprising:
first and second power sources;
a primary path positioned between the first power source and the air mover, the primary path having a first state in which the primary path electrically couples the first power source to the air mover to apply electrical power to the air mover, and the primary path having a second state in which the primary path has a lower conductivity than in the first state;
a secondary path coupled between the second power source and the air mover and being in parallel with the primary path, the secondary path comprising a first state in which the secondary path applies supplemental electrical power from the second power source to the air mover, and the secondary path comprising a second state that has a lower conductivity than the first state of the secondary path;
a secondary path switch operatively coupled to the secondary path;
a controller operatively coupled to the secondary path switch and responsive to at least one of the first and second states of the primary path, wherein the controller causes the secondary path switch to close and the secondary path to assume the first state when the primary path is in the first state, and the controller causes the secondary path switch to open and the secondary path to assume the second state when the primary path is in the second state.

8. A system as recited in claim 7, wherein the controller comprises a microcontroller.

9. A system as recited in claim 7, further comprising a primary path state sensor operatively coupled to the secondary path switch.

10. A system as recited in claim 7, further comprising primary path state sensing means operatively coupled to the secondary path switch for sensing at least one of the first and second states of the primary path and communicating the at least one sensed state of the primary path to the secondary path switch.

11. A system as recited in claim 7, wherein:
the first state of the primary path comprises a “high” state.

12. A system as recited in claim 7, wherein the second power source comprises the first power source.

13. A system as recited in claim 7, wherein the first and second power supplies are the same.

14. A system for powering an air mover of a vehicle air temperature control system, the air mover powering system comprising:
first and second power sources;
a primary path positioned between the first power source and the air mover, the primary path having a first state in which the primary path electrically couples the first power source to the air mover to apply electrical power to the air mover, and the primary path having a second state in which the primary path has a lower conductivity than in the first state;
a secondary path coupled between the second power source and the air mover and being in parallel with the primary path, the secondary path comprising a first state in which the secondary path applies supplemental electrical power from the second power source to the air mover, and the secondary path comprising a second state that has a lower conductivity than the first state of the secondary path; and
control means operatively coupled to the secondary path and responsive to at least one of the first and second states of the primary path for causing the secondary path to assume the first state when the primary path is in the first state, and for causing the secondary path to assume the second state when the primary path is in the second state.

15. A system for powering an air mover of an air temperature control system, the air mover powering system comprising:
first and second power sources;
a primary path positioned between the first power source and the air mover, the primary path having a first state in which the primary path electrically couples the first power source to the air mover to apply electrical power to the air mover, and the primary path having a second state in which the primary path has a lower conductivity than in the first state;
a secondary path coupled between the second power source and the air mover and being in parallel with the primary path, the secondary path comprising a first state in which the secondary path applies supplemental electrical power from the second power source to the air mover, and the secondary path comprising a second state that has a lower conductivity than the first state of the secondary path; and
means operatively coupled to the secondary path for selecting one of the first and second states of the secondary path based upon at least one of the first and second states of the primary path.

16. A system for powering an air mover of an air temperature control system for a vehicle, the vehicle comprising first and second power sources and the air temperature control system comprising a primary path positioned between the first power source and the air mover, the primary path comprising a first state in which the primary path electrically couples the first power source to the air mover to apply electrical power to the air mover, and the primary path having a second state in which the primary path has a lower conductivity than in the first state, the air mover powering system comprising:
a secondary path coupled between the second power source and the air mover and being in parallel with the primary path, the secondary path comprising a first state in which the secondary path applies supplemental electrical power from the second power source to the air mover, and the secondary path comprising a second state that has a lower conductivity than the first state of the secondary path; and
means operatively coupled to the secondary path for selecting one of the first and second states of the secondary path based upon at least one of the first and second states of the primary path.

17. A system for powering an air mover of an air temperature control system for a vehicle, the vehicle comprising first and second power sources and the air temperature control system comprising a primary path positioned between the first power source and the air mover, the primary path comprising a first state in which the primary path electrically couples the first power source to the air mover to apply electrical power to the air mover, and the primary path comprising a second state that has a lower conductivity than the first state of the primary path, the air mover powering system comprising:
a secondary path coupled between the second power source and the air mover and being in parallel with the primary path, the secondary path comprising a first state in which the secondary path applies supplemental electrical power from the second power source to the air mover, and the secondary path comprising a second state that has a lower conductivity than the first state of the secondary path; and
a controller responsive to at least one of the first and second states of the primary path, wherein the controller causes the secondary path to assume the first conduction path when the primary path is in the first state, and the controller causes the secondary path to assume the second state when the primary path is in the second state.

18. A system for powering an air mover of an air temperature control system for a vehicle, the vehicle comprising first and second power sources and the air temperature control system comprising a primary path positioned between the first power source and the air mover, the primary path comprising a first state in which the primary path electrically couples the first power source to the air mover to apply electrical power to the air mover, and the primary path comprising a second state that has a lower conductivity than the first state of the primary path, the air mover powering system comprising:
a secondary path coupled between the second power source and the air mover and being in parallel with the primary path, the secondary path comprising a first state in which the secondary path applies supplemental electrical power from the second power source to the air mover, and the secondary path comprising a second state that has a lower conductivity than the first state of the secondary path; and
control means responsive to at least one of the first and second states of the primary path for causing the secondary path to assume the first conduction path when the primary path is in the first state, and for causing the secondary path to assume the second state when the primary path is in the second state.

19. A method for powering an air mover of a vehicle air temperature control system, the method comprising:
providing first and second power sources;
positioning a primary path between the first power source and the air mover, the primary path having a first state in which the primary path electrically couples the first power source to the air mover to apply electrical power to the air mover, and the primary path having a second state in which the primary path has a lower conductivity than in the first state;
positioning a secondary path between a second power source and the air mover in parallel with the primary path, the secondary path comprising a first state in which the secondary path applies supplemental electrical power from the second power source to the air mover, and the secondary path comprising a second state that has a lower conductivity than the first state of the secondary path; and
causing the secondary path to assume the first state when the primary path is in the first conduction state, and causing the secondary path to assume the second state when the primary path is in the second conduction state.

20. A method as recited in claim 19, further comprising sensing at least one of the first and second states of the primary path and selecting a corresponding one of the first and second states of the secondary path in response to the sensed state of the primary path.

21. A method as recited in claim 19, wherein the provision of the first and second power sources comprises providing the first power source and the second power source as a single power source.

22. A method for powering an air mover of a vehicle air temperature control system, the method comprising:
providing first and second power sources;
positioning a primary path between the first power source and the air mover, the primary path having a first state in which the primary path electrically couples the first power source to the air mover to apply electrical power to the air mover, and the primary path having a second state in which the primary path has a lower conductivity than in the first state;
positioning a secondary path between a second power source and the air mover in parallel with the primary path, the secondary path comprising a first state in which the secondary path applies supplemental electrical power from the second power source to the air mover, and the secondary path comprising a second state that has a lower conductivity than the first state of the secondary path;
causing the secondary path to assume the first state when the primary path is in the first state;
periodically monitoring the state of the primary path by causing the secondary path to assume the second state and sensing the state of the primary path;
when the monitoring of the primary path indicates that the primary path is in the first state, causing the secondary path to resume the first state; and
when the monitoring of the primary path indicates that the primary path is in the second state, causing the secondary path to assume the second state.
